(19) United States
(12) Patent Application Publication
(10) Pub. No.: US 2005/0251758 A1
(43) Pub. Date: Nov. 10, 2005

(54) Indicating file type on thumbnail preview icon

(75) Inventors: Charles Cummins, Seattle, WA (US); Paul Gusmorino, Seattle, WA (US); Jeffrey C. Belt, Bellevue, WA (US); Jenny T. Lam, Seattle, WA (US); Tyler K. Beam, Redmond, WA (US); David G. De Vorchik, Redmond, WA (US); Raymond J. Chen, Redmond, WA (US)

Correspondence Address: BANNER & WITCOFF LTD.,;ATTORNEYS FOR MICROSOFT, 1001 G STREET , N.W., ELEVENTH STREET, WASHINGTON, DC, 20001-4597, US

(73) Assignee: Microsoft Corporation, Redmond, WA (US)

(21) Appl. No.: 11/181,900

(22) Filed: Jul. 15, 2005

Related U.S. Application Data
(63) Continuation-in-part of application No. 10/831,145, filed on Apr. 26, 2004.

(51) Int. Cl. G06F 3/00

(52) U.S. Cl. 715/838

(57) ABSTRACT

A method and system are provided for displaying icons in accordance with user preferences. The method includes providing a user with a size selection mechanism for selecting an icon size from a range of sizes. The method additionally includes searching a set of stored resources related to the underlying file and generating the icon in the selected size based upon the stored resources. The method may additionally include selecting an icon type including one of a traditional icon and thumbnail icon based on at least one of the user's size selection and the represented file. Furthermore, the icon display system may position labels and overlays in the vicinity of the icon based upon the selected size and aspect ratio of the icon.

This application is a continuation-in-part of and claims priority to U.S. application Ser. No. 10/830,224, filed Apr. 23, 2004, and entitled “System and Method for Displaying Stack Icons,” herein incorporated by reference in its entirety for all purposes.

### BACKGROUND

Icons have been used for many years in computer systems to display information to users. Icons are images that are used to represent items such as files, folders, shortcuts, applications, documents, tasks, and commands throughout a computer operating system such as MICROSOFT WINDOWS®, a product of the Microsoft Corporation of Redmond, Wash. Icons are currently used in toolbars, dialog boxes, menus, and numerous other locations in file management systems such as Windows Explorer, also a product of the Microsoft Corporation. Icons are usually stored as static bitmaps, but dynamic icon handlers may also be written to generate icons dynamically.

Currently, two types of icons are used to represent items. These two types include traditional icons and thumbnail icons. Whereas traditional icons are typically shared across files and are determined per type, thumbnails are generally determined per item and are not shared across files (in the case of media files, all tracks from the same album might share the same album art icon, in which case the icon is not a true thumbnail). A traditional icon is composed of two components including an icon image and a status overlay. The icon image forms the basis of the traditional icon. The status overlay is used to convey status information about the item. It is used, for example, to display the shortcut overlay.

A thumbnail icon is a particular type of icon displaying an image generated based on the contents of the underlying item. For example, an icon for an image file that actually looks like the image itself is a thumbnail of the image file. Thumbnail icons may also include an overlay. Thumbnail icons may be dynamically generated by code run on a user computer, although the generated image may be cached.

Although existing operating systems offer thumbnails, these thumbnails are not well integrated into existing file management systems such as Windows Explorer. As a result, the thumbnail feature is not as useful as it could be. A user has to go to a special “thumbnails view” to see thumbnail icons today, even for objects having thumbnail icons that would be visually effective at a smaller size, such as photographs. When in the thumbnails view of existing systems, icons for objects without thumbnails appear small and inadequate. The user typically cannot see extra information about each file in thumbnails view as the user can in other views such as tile view or details view. Accordingly, the user is often forced to choose between viewing thumbnails and viewing other important information.

Because the thumbnails feature is remote and not extensively utilized, little incentive exists for Independent Software Vendors (ISVs) to write thumbnail generators, When ISVs do write the thumbnail generators, they are unlikely to invest in making the thumbnail generators powerful. As a result, many existing application produce thumbnails of poor quality. Generally, since thumbnails are pictures, it is difficult to determine what type of item underlies a thumbnail icon. Furthermore, while traditional icons appear instantly, thumbnail icons are typically noticeably slow to appear because they were not generated in advance.

With traditional icons, overlays are often used as a primary or only indication of information about an item underlying an icon. However, overlays do not reliably appear. If multiple states need to be shown, overlays will only show the highest priority state and will ignore others since no more than one overlay may be shown at a time. Overlays are difficult to recognize at small icon sizes, such as the sizes generally used in list or details mode. Overlays have additional drawbacks including the ability to be readily imitated and used in an unauthorized manner. A further limitation is the inaccessibility of overlays to the visually-impaired. A user navigating with the keyboard and using a narrator hears a name and type of each file as the file is selected, but is not given any information about a state that the overlay represents. Additionally, overlays are used inconsistently to convey information about the state of a file.

### SUMMARY

Features described herein are directed to a method for displaying an icon representing an underlying file on a user interface. The method may include providing a user with a size selection mechanism for selecting an icon size from a range of sizes. The method may further include searching a set of stored resources related to the underlying file and generating the icon in a user selected size based upon the stored resources.

In another aspect, a method is provided for enhancing display of icons on a user interface. The method may provide a user selection component for allowing a user to select an icon size for an icon representing a file. The method may additionally include selecting an icon type including one of a traditional icon and a thumbnail icon based on at least one of the size selection and the represented file. The method may additionally include generating the selected icon having the selected size and icon type.

In yet an additional aspect, a system is provided for enhancing icon display. The system may include a user icon scaling module for allowing a user to select an icon size for an icon representing an underlying file. The system may additionally include a resource selection module for selecting an image resource for generating the icon based on the size selection.

In yet a further aspect, a system is provided for enhancing icon display. The system may include a user icon scaling module for allowing a user to select an icon size for an icon representing an underlying file. The system may additionally include a type selection module for selecting a type of icon including at least one of a traditional icon and a thumbnail icon, the type selection based on at least one of the size selection and the underlying file.

Other aspects may provide various mechanisms for selecting a type overlay for displaying in conjunction with the thumbnail icon, including selection based on a file type, a corresponding application program, input received through an application programming interface (API), and/or the contents of the data file to which the icon corresponds, among other mechanisms.

### BRIEF DESCRIPTION OF THE DRAWINGS

The features described in detail below are described with reference to the attached drawings figures, wherein:

FIG. 1 is a block diagram illustrating a computerized environment in which features described herein may be implemented;

FIG. 2 is a block diagram illustrating an icon scaling system in accordance with several features described herein;

FIGS. 3A-3G are samples or different types and sizes of icons;

FIG. 4 is a block diagram illustrating an icon configuration;

FIG. 5 illustrates several thumbnail icon configurations;

FIGS. 6A-6F illustrate multiple embodiments of visual effects for icons;

FIG. 7 illustrates a user scale for allowing a user to scale icons;

FIG. 8 is a flow chart illustrating a process for determining what type of icon to use;

FIG. 9 is a flow chart illustrating a process for accessing image resources; and

FIG. 10A illustrates Table 2, which shows one embodiment of the overlay sizes relative to icon sizes along a continuous range.

FIG. 10B illustrates Table 7, which shows another embodiment of the overlay sizes relative to icon sizes along a continuous range.

FIG. 11 illustrates a method for determining a thumbnail type overlay according to various features described herein.

### DETAILED DESCRIPTION

I. System Overview

Features described herein include a method and system for enabling scaling of icons C to enhance a user experience. Icon scaling enables users to resize the icons in file management systems, such as Microsoft Windows Explorer, to any size in a range from a small size appropriate for looking at a long list of items to a very large size appropriate for looking at a small number of thumbnails within a single view. As an icon is resized, the appearance and layout of the icon may change to best accommodate its new size.

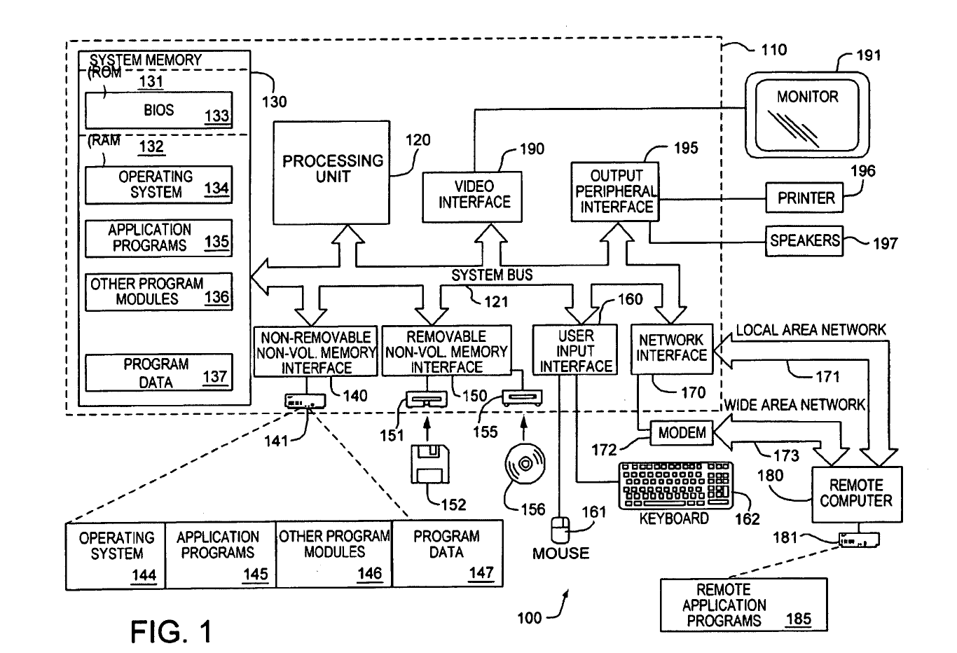

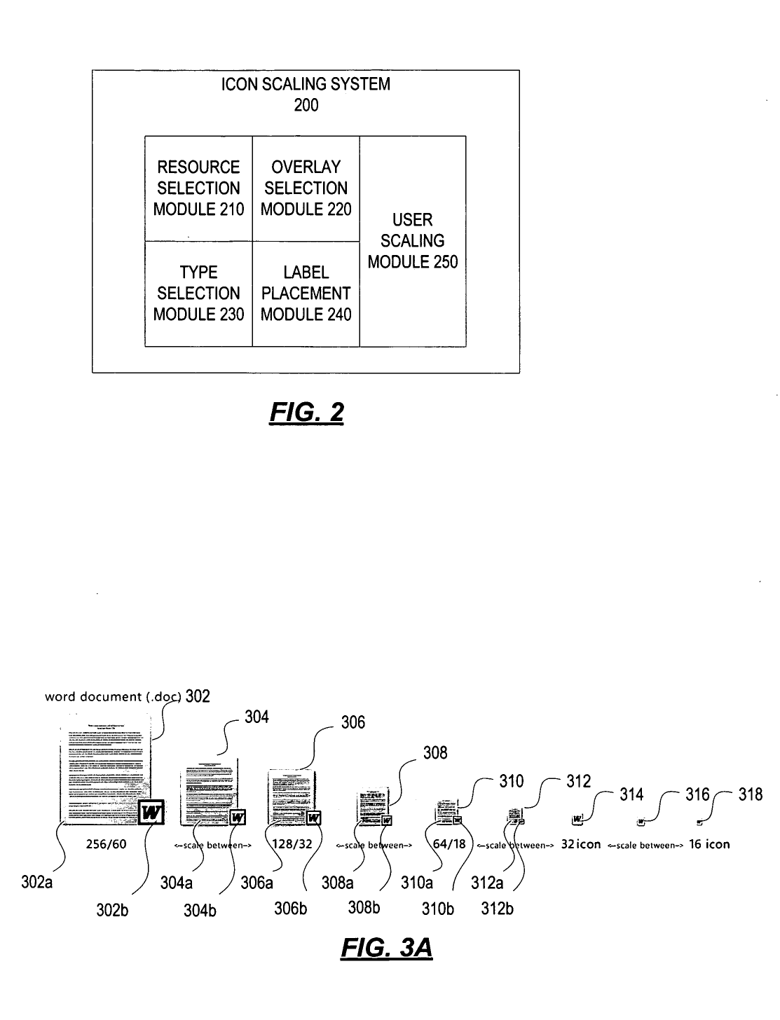

FIG. 2 illustrates an icon scaling module 200. The icon scaling module 200 may be implemented as one or more program modules in a computerized environment as described below with reference to FIG. 1. The icon scaling module 200 may include a resource selection module 210, an overlay selection module 220, a type selection module 230, a label placement module 240, and a user scaling module 250. Through the user scaling module 250, a user is able to select an icon size. Based on the user scaling selection, the type selection module 230 may select a type of icon such as a thumbnail or traditional icon. The resource selection module 210 may also select a particular image resource for scaling based on the scaling selection. Similarly, in some aspects, the overlay selection module 220 may select, scale, and/or position a status overlay and/or a type overlay based on the scaling selection, and the label placement module 240 may determine an appropriate location for a label associated with the icon based on the scaling selection.

Icons may be authored using a predetermined set of sizes, such as 16×16 pixels and 32×32 pixels. When a user chooses to view an icon at a size that is not one of the predetermined sizes, the scaling module 200 may interpolate to determine what image to show the user. When the size of an icon is changed, variables including the type of icon, the image resource, label placement, and/or overlay configuration may be affected as set forth herein.

II. Exemplary Operating Environment

FIG. 1 illustrates an example of a suitable computing system environment 100 on which the features described herein may be implemented. The computing system environment 100 is only one example of a suitable computing environment and is not intended to suggest any limitation as to the scope of use or functionality of the features described herein. Neither should the computing environment 100 be interpreted as having any dependency or requirement relating to any one or combination of components illustrated in the exemplary operating environment 100.

The features herein are described in the general context of computer-executable instructions, such as program modules, being executed by a computer. Generally, program modules include routines, programs, objects, components, data structures, etc. that perform particular tasks or implement particular abstract data types. The features may be practiced with other computer system configurations, including hand-held devices, multiprocessor systems, microprocessor-based or programmable consumer electronics, minicomputers, mainframe computers, and the like. The features may also be practiced in distributed computing environments, where tasks may be performed by remote processing devices that are linked through a communications network. In a distributed computing environment, program modules may be located in both local and remote computer storage media including memory storage devices.

With reference to FIG. 1, the exemplary system 100 may include a general purpose-computing device in the form of a computer 110, which may include a processing unit 120, a system memory 130, and a system bus 121 that couples various system components including the system memory to the processing unit 120.

Computer 110 may include a variety of computer readable media. By way of example, and not limitation, computer readable media may comprise computer storage media and communication media. The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/nonremovable, volatile/nonvolatile computer storage media. By way of example only, FIG. 1 illustrates a hard disk drive 141 that reads from or writes to nonremovable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 may be connected to the system bus 121 through a non-removable memory interface such as interface 140, and magnetic disk drive 151 and optical disk drive 155 may be connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices may be connected to the processing unit 120 through a user input interface 160 that is coupled to the system bus, but may be connected by other interface and bus structures, such as a parallel port, game port or a universal serial bus (USB). A monitor 191 or other type of display device may also be connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks.

When used in a LAN networking environment, the computer 110 may be connected to the LAN 171 through a network interface or adapter 170. When used in a WAN networking environment, the computer 110 may include a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnection are well known.

III. Sample Icons

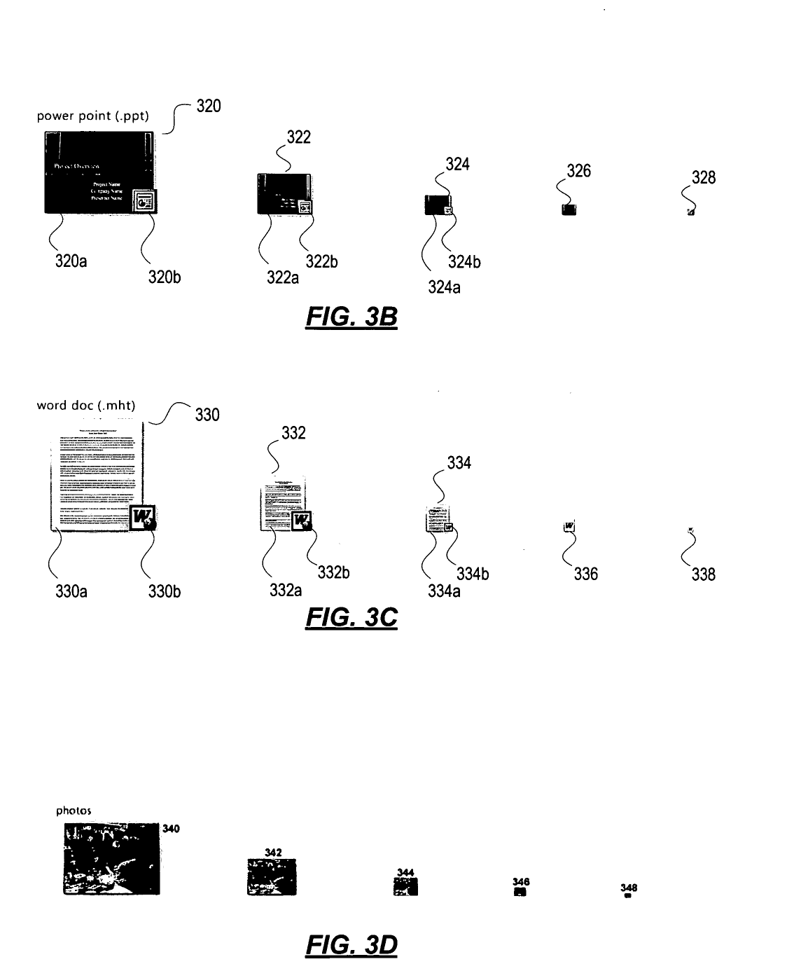

FIGS. 3A-3G illustrate a sampling of icons in various sizes. FIG. 3A illustrates a sampling of document icons 302, 304, 306, 308, 310, 312, 314, 316, and 318. The document icons 302, 304, 306, 308, 310, and 312 each include respective document images 302a, 304a, 306a, 308a, 310a, and 312a. Each of the aforementioned document icons additionally includes a type overlay 302b, 304b, 306b, 308b, 310b, and 312b. These type overlays indicate a type of the underlying document (e.g., word processing file, picture file, video file, audio file, spreadsheet, etc.). The document icon 302 is shown has having a 256×256 pixel overall icon size and a 60×60 pixel type overlay portion. The images and overlays may be scaled independently of one another, such that the image 304a is scaled between the images 302a and 306a and the overlay 304b is scaled between the overlays 302b and 306b. In the depicted example, document icon 306 is the next available document size. The overall size of icon 306 is 128×128 pixels and the overlay portion is 32×32 pixels. Document icon 304 is an icon scaled between the standard sized icons 302 and 306. Similarly, document icon 308 is scaled between the document icon 306 and the document icon 310, which includes a 64×64 overall icon size and an 18×18 pixel overlay portion 310b. Document icon 314 is a 32×32 pixel icon that includes only an overlay portion because its size is too small to clearly display both an overlay and a document image. Document icon 312, which is scaled between document icon 310 and 314 show both the document image portion 312a and the type overlay portion 312b. Smaller icons 316 and 318 both show only the type overlay portion of the item. The respective type overlays indicate the type of document such as a MICROSOFT WORD™ document. The document icons may be provided in many sizes, including 16×16, 24×24, 32×32, 48×48, 128×128, and 256×256 pixels. Alternatively, some of these sizes may be omitted and/or additional sizes may be included.

FIG. 3B illustrates a set of MICROSOFT POWERPOIN™ Icons 320, 322, 324, 326, and 328. The Icons 320, 322, and 324 include an image portion 320a, 322a, and 324a. The icons 320, 322, and 324 also include overlay portions 320b, 322b, and 324b. The icons 326 and 328 are too small to be displayed with both portions. Accordingly these icons include only a thumbnail image. The decision to show a thumbnail image or an overlay may be made on a per type basis.

FIG. 3C also includes a set of icons 330, 332, 334, 336, and 338. The icons 330, 332, and 334 include respective image portions 330a, 332a, and 334a and overlay portions 330b, 332b, and 334b indicating that the document is an .mht document. Icons 336 and 338 are too small to adequately display both portions, and therefore include only the type overlay portion to indicate the type of underlying document.

FIG. 3D illustrates a plurality of scaled photo icons 340, 342, 344, 346, and 348. These icons are preferably thumbnail icons that include a photograph from within the underlying file. The thumbnail icons shown display useful information and include no overlay portion.

FIG. 3E illustrates a set of video icons 350, 352, 354, 356, and 358. The icons 350, 352, and 354 each include a respective image portion 350a, 352a, and 354a. The included images may be thumbnail images. The icons 350, 352, and 354 each also include a respective type overlay portion 350b, 352b, and 354b. The icons 356 and 358 include only the image portion, which may be a thumbnail image, as the icons are too small to include both portions.

FIG. 3F illustrates a set of contact icons 360, 362, 364, 366, 368, and 370. The icons 360 and 362 each include a respective image portion 360b and 362b, which may be a thumbnail image, and a respective informational portion 360a and 362a. Icons 364, 366, and 368 include only an image portion, as the icons are too small to show both the image and informational portion. Icon 370 illustrates a generic image that may be shown if a thumbnail image is unavailable.

FIG. 3G illustrates a generic contact icon 372 that may be used when no photograph is available for the contact. The icon 372 includes a generic image 372b and an informational portion 372a.

IV. Overlays

As set forth above, the different icon sizes may also include different overlay sizes. As set forth above with respect to FIG. 2, the selection and placement of overlays may be based on user-selected scaling. The overlay selection module 220 determines an overlay configuration based on user scaling input.

Two kinds of overlays include status overlays and type overlays. The overlays shown above with respect to FIGS. 3A-G are type overlays that indicate a type. The type overlay may be used for thumbnail icons to convey what type of object the thumbnail image portrays. The type overlays appear in a lower right-hand corner of the image. Status overlays serve as a visual cue to help a user quickly identify some piece of relevant information about an item being viewed. Status overlays may appear in a lower left hand corner of an image.

One use of a status overlay includes alerting the user of a transitional or temporary state of a file upon which a user may wish to act. An example would be putting a “new” overlay on a file that has just recently been created. Another possible use for a status overlay is indicating relevant context sensitive information upon which a user may wish to act. An example would be putting an “error” overlay on a file in the download manager that could not complete downloading. In general, information that is being conveyed through a status overlay should also be a property that can be used for sorting, grouping, stacking, filtering, and searching.

Table 1 describes size overlays that may be displayed on icons of different sizes.

TABLE 1

| Icon Size | Corresponding Overlay Size |
|---|---|
| 256 × 256 | 48 × 48 |
| 128 × 128 | 32 × 32 |
| 48 × 48 | 24 × 24 |
| 32 × 32 | 16 × 16 |
| 16 × 16 | 8 × 8 |

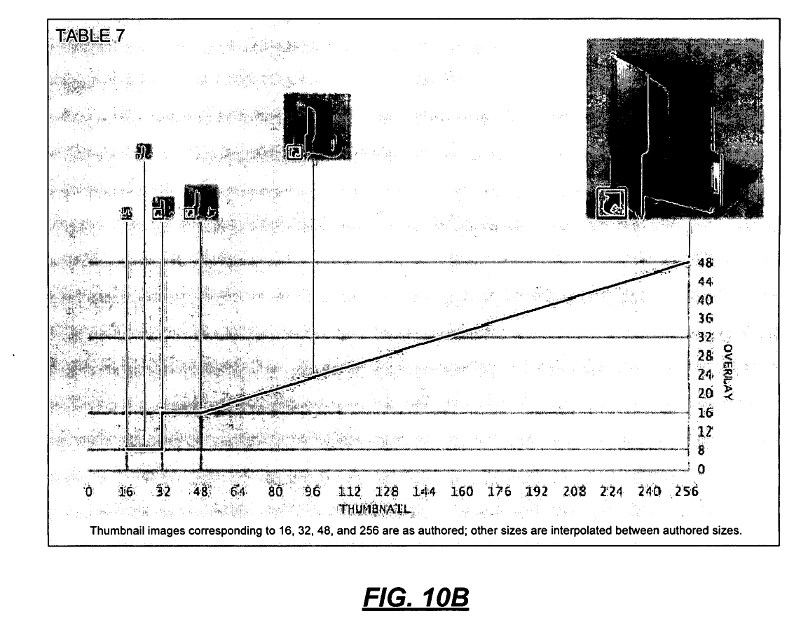

The overlays may scale independently from the icons. Between each defined icon snap size such as 256×256, 128×128, 64×64, 32×32, and 16×16, the overlays may scale linearly between the two overlay sizes. FIG. 10A illustrates Table 2, which shows one embodiment of the overlay sizes relative to icon sizes along a continuous range. FIG. 10B illustrates Table 7, which shows another embodiment of the overlay sizes relative to icon sizes along a continuous range. Those of skill in the art will appreciate that Tables 2 and 7 are merely illustrative, and other values and sizes may be used.

V. Icon Types and Layouts

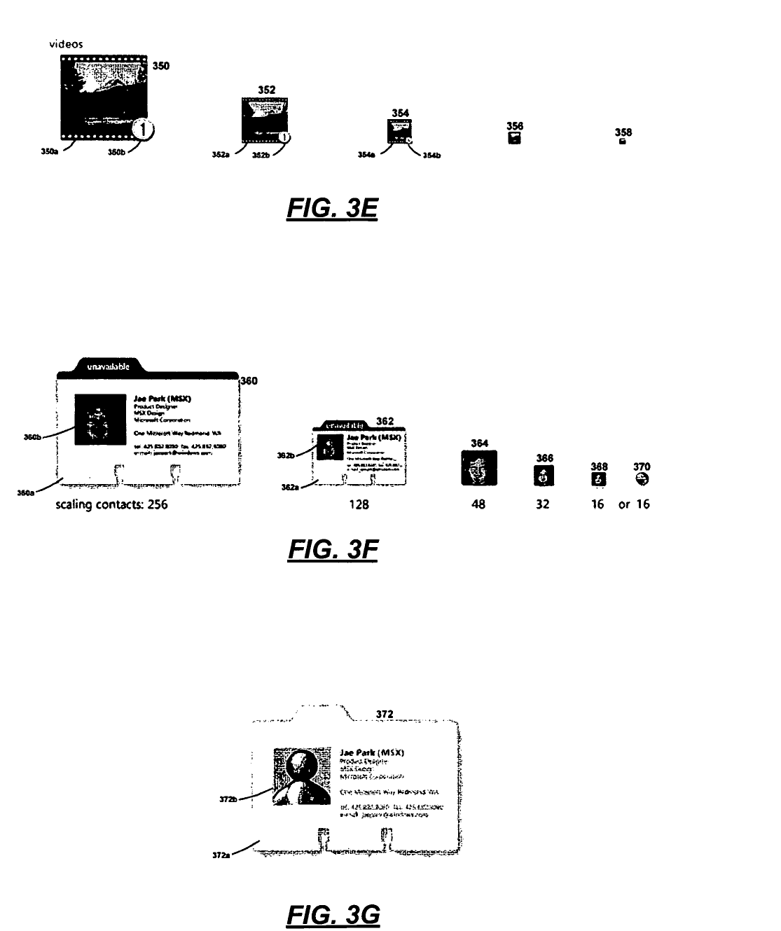

FIG. 4 illustrates a traditional icon 400 including an icon image 401 and a status overlay 402. The icon image 401 may be stored as a bitmap or may be dynamically generated. The status overlay 402 is used to convey status information about an item. The status overlay may also be dynamically generated or may be stored as a bitmap. In the displayed embodiment, the icon image 401 has dimensions of width=height=X. In some aspects, the status overlay 402 is drawn at the bottom left corner of the image so that the bottom edge of the overlay 402 is aligned with the bottom edge of the icon 400 and the left edge of the overlay 402 is aligned with the left edge of the icon 400. Alternatively, the layout may be configured differently.

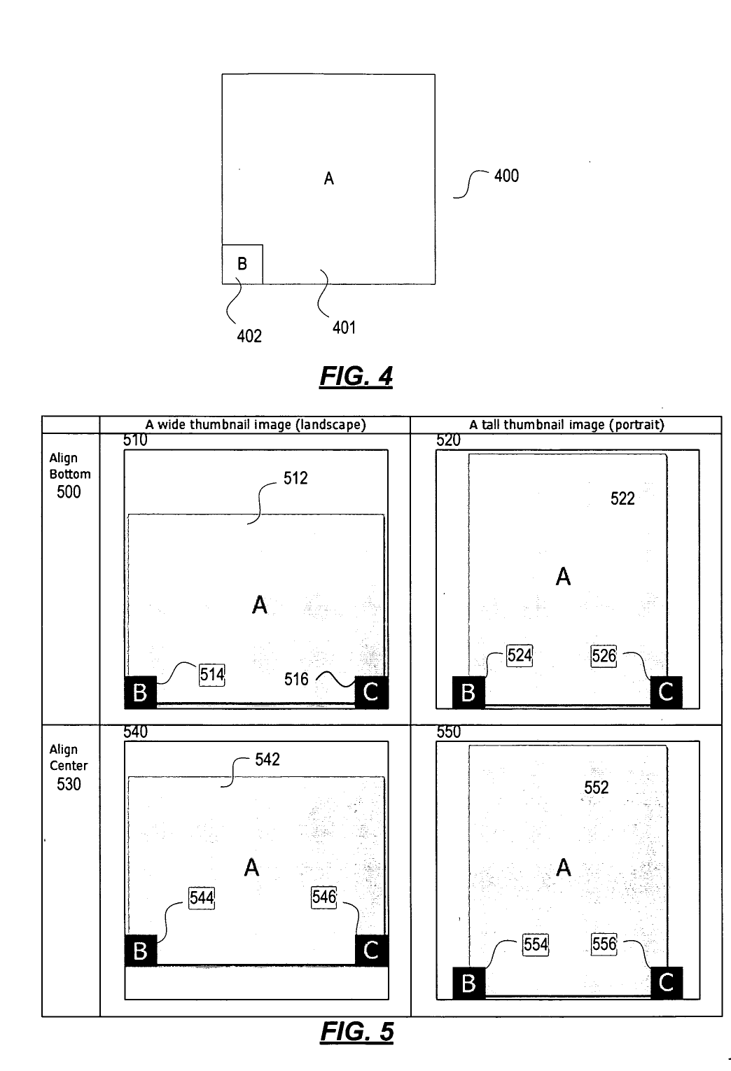

FIG. 5 illustrates possible layouts for a thumbnail icon. A row 500 illustrates bottom aligned thumbnail icons 510 and 520. A row 530 illustrates centrally aligned thumbnail icons 540 and 550. The bottom-aligned thumbnail icon 510 includes an image portion 512, a status overlay 514, and a type overlay 516. The bottom-aligned thumbnail icon 520 includes an image portion 522, status overlay 524, and a type overlay 526. The thumbnail icon 540 includes an image portion 542, a status overlay 544, and a type overlay 546. The thumbnail icon 550 includes an image portion 552, a status overlay 554, and a type overlay 556. In general, the image within each icon is denoted by (A), the status overlay by (B), and the type overlay by (C). The thumbnail icon itself is a square with a width and height equal to X. The thumbnail image (A) is scaled so that its longest dimension is at most equal to X.

As illustrated in FIG. 5, in all of the displayed configurations, the thumbnail image (A) is drawn horizontally centered within the thumbnail icon. The vertical placement of the thumbnail image (A) may be determined by the type of view. If a current view has text labels placed below the icon then the bottom edge of the thumbnail image (A) may lie along the bottom edge of the thumbnail icon. If the current view has text labels placed to the side of the icon, then the thumbnail image (A) may be vertically centered within the thumbnail icon.

The placement of the status overlay (B) may depend on the placement of the thumbnail image (A) within the thumbnail icon. The depicted status overlay (B) fits within the boundaries of the thumbnail icon. Horizontally, the status overlay (B) may be centered around the left edge of the thumbnail image (A), but may be moved to the right when necessary, to avoid extending over a left boundary of the thumbnail icon itself.

The placement of the type overlay (C) may depend on the placement of the thumbnail image (A) within the thumbnail icon. Vertically, like the status overlay (B), the bottom edge of the type overlay (C) may lie along the bottom edge of the thumbnail image such that the type overlay (C) fits within the boundaries of the thumbnail icon when the thumbnail image (A) is bottom-aligned. Horizontally, like a mirror of the status overlay (B), the type overlay (C) may be centered around the right edge of the thumbnail image (A), but may be moved to the left when necessary, to avoid extending over the right boundary of the thumbnail icon itself.

For certain predefined icon sizes, such as icons between 16×16 and 47×47 pixels, the label placement module 240 may position the filename beside the icon. For example, for sizes 32×32 to 47, the label placement module 240 may provide additional tile information beside the icon. For sizes 48×48 and larger, the label placement module 240 may place the filename below the icon.

In a default mode, type overlays may be shown on a thumbnail icon if and only if it is within the document library. In some instances, type overlays will not be shown on photographs or video by default. A setting in the view options may be available to enable users to turn on or off the type overlays on documents. A mechanism such as an application program interface (API) may be provided that allows applications to associate a type overlay with each file type they own.

VI. Visual Enhancements

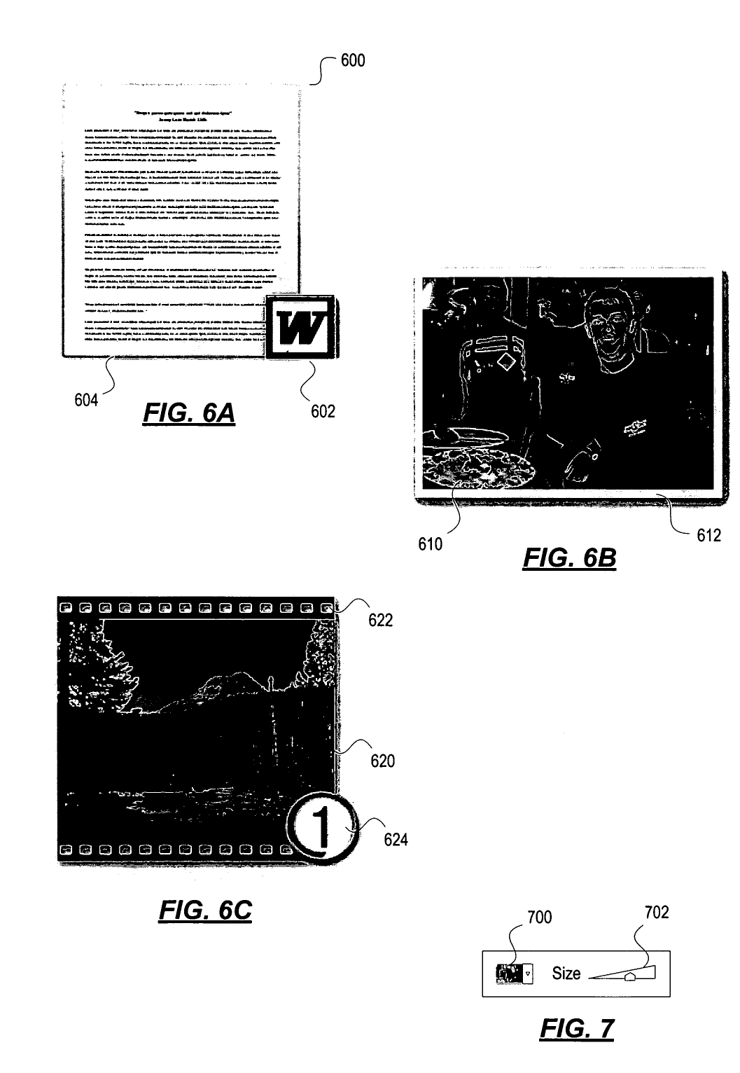

FIGS. 6A-6C illustrate visual enhancements that may be applied to thumbnail icons. There are several types of visual treatments that can be applied to thumbnail images and some of these treatments may further scale down an image.

FIG. 6A illustrates a thumbnail image 600 and a type overlay 602. A border 604 is applied and the icon may be registered to receive such a treatment. For example, MICROSOFT WORD™ documents may be registered to have this treatment applied to the m. The border may be applied solely to the thumbnail image 600 and not to the entire bounding box of the thumbnail icon.

FIG. 6B illustrates a thumbnail image 610 having a photo paper border 612. The photo paper border 612 may be applied to a thumbnail if the underlying file is an “image” type and the icon size meets requirements. A photo paper border may be applied to the thumbnail image if the thumbnail image is an image type and it is of a suitable predetermined size, such as 256, 128, 48 or 32 pixels. In this example, no photo paper border is applied at size 16.

Table 3 describes the photo paper border width at each thumbnail icon size in this example.

TABLE 3

| Icon Size | Photo Paper Border Width |
|---|---|
| 256 | 5 |
| 128 | 3 |
| 48 | 2 |
| 32 | 1 |
| 16 | No photo paper border. |

The width may be interpolated between the displayed sizes in a similar manner to the overlays shown in Table 2.

FIG. 6C illustrates a thumbnail image 620 having sprockets 622 and a type overlay 624. The sprockets may be applied to the thumbnail image 620 to convey that it is a movie type. The sprockets include two images placed along the top and bottom of the thumbnail image 620 to make it look like a piece of film strip. A pair of sprockets may be applied to the thumbnail image if it is a perceived video type, and if the thumbnail icon size is of a predetermined size, such as 256, 128, 48, or 32 pixels. Again, in this example, no sprockets are applied at size 16. Table 4 describes the sprocket size at each thumbnail icon size in this example.

TABLE 4

| Icon Size | Sprocket Height |
|---|---|
| 256 | 18 |
| 128 | 10 |
| 48 | 6 |
| 32 | 4 |
| 16 | No sprockets. |

The top sprocket may be placed so that its bottom edge aligns with the top edge of the thumbnail image, and the bottom sprocket may be placed so that its top edge aligns with the bottom edge of the thumbnail image. If the thumbnail image has a height large enough to make the thumbnail image with the sprockets higher than X pixels, then the two sprockets may be moved closer to one another. The top sprocket may be moved down and the bottom sprocket may be moved up until the thumbnail image with the applied sprockets is no taller than the height X.

Other effects may include a gradient effect that may be applied to thumbnail image to make it more attractive. Furthermore, a shine effect may be applied to the thumbnail image if the object type has been registered to receive such a treatment. For example, POWERPOINT™ types may be registered to have this treatment applied to them. A thumbnail icon may also include a drop shadow effect or other visual effect.

VII. Using the Scaling Mechanism

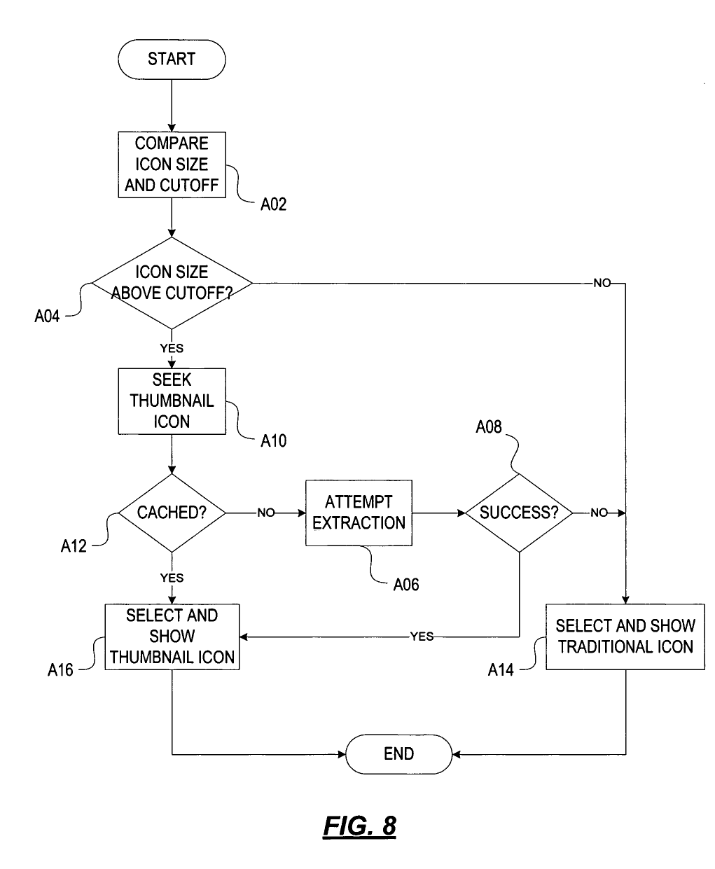

As set forth above, and as illustrated in FIG. 2, a user scaling module 250 receives user input for scaling. FIG. 7 illustrates a user scale for allowing a user to scale icons. Users can scale icons to certain predetermined sizes, such as between 16×16 and 256×256 pixels. An icon size slider 702 may be provided in a view pane. A view mode control 700 allows a user to switch between an icon mode and a details mode. A user can move the icon slider 702 to adjust the icon size. The icon size slider 702 may have snap points around sizes 16, 32, 48, 128, and 256. If the slide control indicates a size within a few pixels of one of the snap sizes, the icons will snap to that size. In some aspects, if the slider control is within four pixels in either direction of a snap size, the selected icons will be set at the snap size.

Additionally, a view menu may have an item labeled “Icon Size,” with the following choices appearing off a submenu: Tiny, Small, Medium, Large, and Huge, or similar selections that correspond to icon sizes such as 16, 32, 48, 128, and 256. For example, the view menu may be a pull-down menu listing selectable options, and the listed menu options may be selected by clicking, right-clicking, etc.

Finally, users may be able to scale icons using a scroll wheel found on many mice. Moving the scroll wheel forward while holding down the CTRL key can increase the size of the icon and moving the scroller wheel backward while holding down the CTRL key can decrease the size of the icon.

In absence of user scaling, the icons may have default sizes. The following Table 5 describes the default sizes of icons in various folder locations.

TABLE 5

| Place | Default Icons Size | Default Details Size |
|---|---|---|
| Document Library | 48 | 16 |
| Photo/Video | 128 | 16 |
| Library | | |
| Music/Radio | 48 | 16 |
| Library | | |
| Contact Library | 48 | 48 |

If the user selection requires that the icon be scaled between snap sizes, the system utilizes a scaling mechanism including a mechanism for converting the icons to an appropriate format, such as DX9 textures. A hardware accelerated scaling mechanism may implement a bilinear filter or other known mechanism to perform the actual icon scaling while maintaining visual fidelity of the image. The scaling may occur in real-time by the icon scaling system 200. The real-time scaling can occur at draw time or optionally at other times.

VIII. Type Selection Process

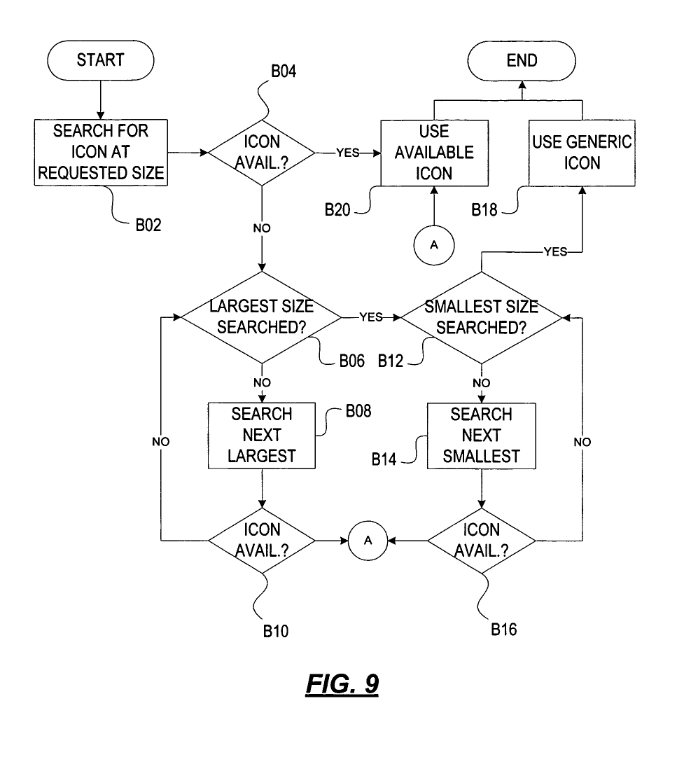

FIG. 8 is a flow chart illustrating a process implemented by the type selection module 230, shown in FIG. 2, for determining which type of icon should be used after a user has selected a particular icon size as explained above with respect to FIG. 7. As set forth above with regard to FIG. 2 the selection of a thumbnail icon or traditional icon typically depends upon the scaling selection of the user.

In step A02, the system compares the icon size and a pre-set size cutoff. If the icon size is above the pre-set size cutoff in step A04, the system seeks a thumbnail icon in step A10. If the icon is not above the size cutoff in step A04, the system selects and shows a traditional item in step A14.

In step A10, the system seeks a thumbnail icon. If a thumbnail icon is not cached in step A112, the system attempts to extract it in step A06. If the thumbnail is not cached in step A12, or if the extraction is successful in step A08, the system selects and shows the thumbnail icon in step A16. If the extraction is unsuccessful in step A08, the system selects and shows the traditional icon in step A14.

Exemplary icon size cutoffs are illustrated in Table 6 below.

TABLE 6

| Perceived Item Type | Thumbnail/Icon Cutoff |
|---|---|
| Document | 32 |
| Folder | 32 |
| Picture | Always thumbnail |
| Video | Always thumbnail |
| Stack (Phodeo) | Always thumbnail |
| Song | Always thumbnail |
| Stack (Album) | Always thumbnail |
| Stack (Artist) | Always thumbnail |
| People | Always thumbnail |
| Groups | Always thumbnail |
| Devices | Always thumbnail |
| Internet Shortcuts | 16 |

IX. Resource Selection and Scaling Process

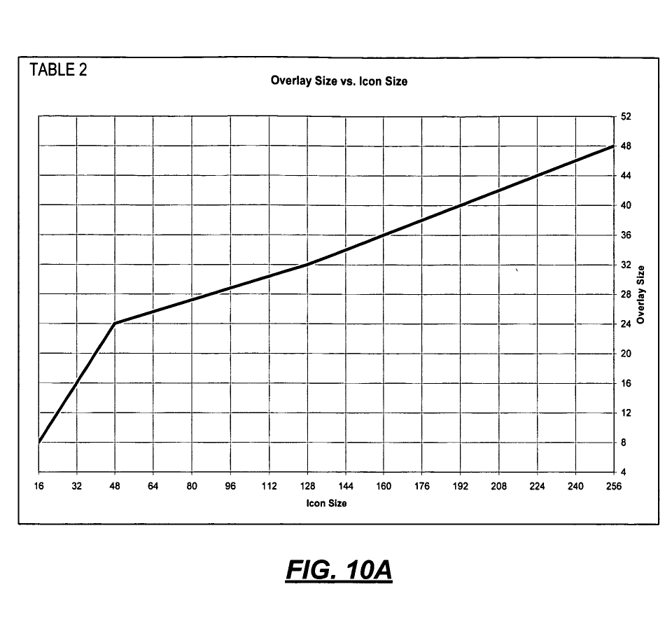

FIG. 9 illustrates a process for selection of an image resource by the resource selection module 210, illustrated in FIG. 2, after a user has scaled a selected icon.

As set forth above, the system may provide image snap sizes. The sizes might include for example 16, 32, 48, 128, and 256 pixels. For every item Y at any size X the system may choose the image at the best available size for Y. In step B02, the system searches for the appropriate sized image X. If X is a snap size and an image for Y is available at size X in step B04, then the system uses the available image at size X in step B20. If an image for Y is not available in size X, in step B04, then the system determines if the largest size was searched in step B06. If the largest size was not searched in step B06, the system searches the next largest size in step B08. If the next largest image is available in step B10, the system uses the available icon in step B20. If the image is not available in step B10, the system continues the search until the largest image has been searched.

Subsequently, in step B12, if the search for larger images representing Y was unsuccessful, the system determines if the smallest size has been searched. If the smallest size has not been searched, the system continues to search for the next smallest size in step B14. If the image is available in step B16, the system uses it in step B20. If the icon is not available and the smallest size has been searched in step B12, the system uses a generic image in step B18. If and only if no image can be found at any size, the system will show a generic image. Although the process above is described as considering larger images prior to smaller images, the reverse process is also encompassed.

If the user selection requires that the image be scaled between snap sizes, the system utilizes a scaling mechanism including a mechanism for converting the images to an appropriate format, such as DX9 textures. A hardware accelerated scaling mechanism may implement a bilinear, bicubic, or other high quality filter, e.g., a fant filter, to perform the actual image scaling. In addition to scaling the retrieved image, the system also attempts to re-extract at the correct size. The system uses the closest stored image it can find in the interim time. Once the system re-extracts, it displays the correctly sized image and also stores the new correctly sized image into a cache for subsequent retrieval. This extraction, display, store-into-cache sequence also occurs if the cache is empty and first displays the traditional icon.

X. Overlay Selection

As described above, the overlay selection module 220 (FIG. 2) determines what type of overlay to display with each thumbnail icon. The overlay selection module 220 may determine which type overlay to place over an icon using any of a variety of methods and mechanisms. For example, an individual file may specify a type overlay to be used (or that no type overlay should be used), the type overlay may be selected based on an application to which the file type corresponds (the corresponding application specifies the type overlay to be used), the overlay selection module may use a variation of the corresponding application's icon as the type overlay (e.g., in reduced size), or the overlay selection module may select a default type overlay (or none at all). The overlay selection module may determine that type overlays are used for a first genre of file types (e.g., data files such as .doc, .xls, etc.), but not used for a second genre of file types (e.g., multimedia files such as tif, gif, jpg, .png, .bmp, .mpg, .wav, .avi, etc.).

According to another feature, where a file type is ambiguous, the overlay selection module may analyze contents (and/or metadata) of a file to determine which type overlay to use. For example, the file type .mht is an ambiguous extension, because it does not uniquely identify the application used to create it. A .mht file refers to a multimedia HTML file, which can be created and edited by multiple applications (e.g., Microsoft® Word® brand word processor and Microsoft® Excel® brand spreadsheet can each create and edit .mht files). In addition, whichever application initially created the .mht file is usually best suited to subsequently edit the .mht file if necessary. The overlay selection module 220 thus either analyzes the file, or causes the file to be analyzed by another appropriate module, and selects the type overlay based on the results of the analysis. For example, if the analysis of a .mht file reveals that Microsoft® Excel® was used to create the .mht file, or that the .mht file contains spreadsheet data, then a first type overlay might be used. If the analysis of the .mht file reveals that Microsoft® Word® was used to create the .mht file, or that the .mht file contains word processing data, then a second type overlay might be used. Those of skill in the art will appreciate that this is but one example of an ambiguous file type, and others may be analyzed as well.

According to another feature, a type overlay may be animated. In such a case, the overlay selection module either animates the type overlay or causes the type overlay to appear animated (e.g., instructing another software module (not shown) to animate the type overlay).

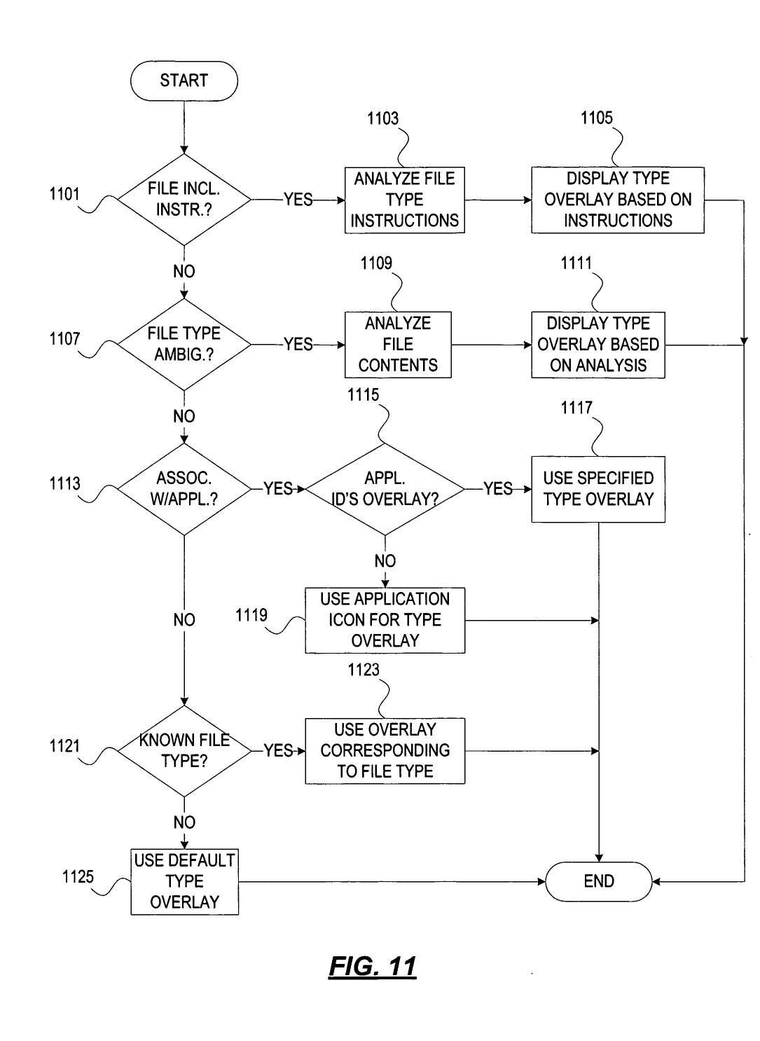

FIG. 11 illustrates a method for selecting a type overlay according to illustrative features described herein. In step 1101, the overlay selection module 220 determines whether the file itself contains or refers to instructions for determining the type overlay for the thumbnail icon corresponding to that file. If so, in step 1103 the overlay selection module analyzes such instructions. For example, the file may include instructions that indicate a specific type overlay should be used, regardless of the application to which the file corresponds, or might indicate that no file type overlay should be used. In step 1105 the overlay selection module displays the type overlay (if any) identified by the instructions.

In step 1107 the overlay selection module 220 determines whether the file type (e.g., the extension) of the underlying file to which the icon corresponds is ambiguous. If so, in step 1109 the system analyzes the file, e.g., by examining its contents or metadata associated with the file. In step 1111 the overlay selection module 220 displays a type overlay based on such analysis.

In step 1113, the overlay selection module 220 determines whether the file is associated with or corresponds to an application program. If so, in step 1115 the overlay selection module 220 determines whether the application specifies a type overlay to be used. If the application does specify a type overlay, the type overlay is displayed in step 1117. If the application does not specify a type overlay, then in step 1119 the overlay selection module may display a variation of the application's icon as the type overlay for the file's icon (e.g., a reduced size version of the application icon) for example, as is shown in FIG. 6A.

In step 1121 the overlay selection module 220 determines whether the file type is a known file type, e.g., by determining whether the file has a recognized or known extension. If the file is a known file type, in step 1123 the overlay selection module displays a type overlay corresponding to the file type. If the file is an unknown file type, then in step 1125 the overlay selection module may display a default type overlay, which can include the display of no type overlay at all.

Those of skill in the art will appreciate that the method of FIG. 11 illustrates one set of heuristics that may be used, and that modified or different heuristics may be used based on the above described features. The steps may be modified to be performed in other than the recited order, and additional or different steps may be used.

Using dynamically assigned type overlays as described herein allows a user to recognize the type of an item even when it is represented by a thumbnail (which might otherwise be ambiguous. The overlay selection module (or the operating system at some other level) may expose an application programming interface (API) to allow developers to specify whether the type overlay should be used on a thumbnail icon and, if so, what type overlay should be used. In addition, a user-definable setting may indicate that type overlays should be turned off (or on) globally for all files.

Furthermore, although the discussion above addresses type overlays, the same approach may be used for overlays that identify any characteristic of an object. For example, overlays may be used to convey other characteristics, such as file size, file age, time of last edit, file ownership, project association, etc. Type overlays may be restricted for use with certain types of files, based on user preferences. For example, a user or operating system may specify a setting to only use type overlays with files that are not native image file types. That is, files of type JPG, GIF, TIF, BMP, etc., are native image file types, and typically one application can open and manage all of the them. Thus, the type overlay can optionally be left off the thumbnail icon of such files. Non-native image file types may include DOC, XLS, PPT, and other documents which do not inherently refer to an image, photo, etc.

### XI. CONCLUSION

Thus, icon scaling enables users to resize icons to any size in a range from a small size to a very large size, depending upon user preference. As an icon is resized, the appearance of the icon and the layout of the icons changes to best accommodate its new size.

Users can, in real-time, scale icons across the continuous range of possible sizes, and the scaling is visually appealing. Thumbnail icons may consistently convey what type of object they represent (e.g. Word Document, PowerPoint deck, video clip, etc.) even for thumbnail extractors written by ISVs. Overlays may be used in a consistent and reliable way as visual cues conveying some information about an item.

While particular features have been illustrated and described in detail herein, it should be understood that various changes and modifications might be made without departing from the scope and intent of the description herein. The features described herein are intended in all respects to be illustrative rather than restrictive. Alternatives will become apparent to those skilled in the art. For example, the scaling processes described above may work equally well when scaling up and scaling down the icon size.

From the foregoing it will be seen that the features described herein well adapted to attain some or all of the ends and objects set forth above. It will also be understood that certain features and sub-combinations may be employed without reference to other features and sub-combinations. For example, the steps in the processes described above may be rearranged and/or omitted as desired. Thus, the spirit and scope of the invention should be construed broadly as set forth in the appended claims.

1. A computer-implemented method for displaying a type overlay on a thumbnail icon representing a non-image type data file stored on a computer system, comprising steps of:
a) identifying a thumbnail image corresponding to content of the non-image type data file;
b) determining whether the data file identifies a type overlay and, if so, displaying on a display device a first icon representation of the data file, wherein the first icon representation comprises the thumbnail image and the identified type overlay; and
c) when the data file does not identify a type overlay, determining whether a file type of the data file uniquely corresponds to a predetermined single application program and, if so, displaying on the display device a second icon representation of the data file, wherein the second icon representation comprises the thumbnail image and a type overlay corresponding to the application program.

2. The method of claim 1, further comprising:
d) when the file type of the data file does not uniquely correspond to a predetermined application program:
i) analyzing contents of the data file;
ii) selecting a type overlay based on the analysis of step i); and
iii) displaying on the display device an icon representation of the data file,
wherein the icon representation comprises the thumbnail image and the type overlay selected in step ii), and
when the file type does not uniquely correspond to a predetermined application program, displaying on the display device a third icon representation of the data file, wherein the third icon representation comprises the thumbnail image and a default type overlay.

3. The method of claim 2, wherein the default type overlay comprises a null or empty type overlay.

4. The method of claim 2, wherein the analyzed contents of the data file comprises metadata of the data file.

5. The method of claim 1, wherein the type overlay corresponding to the application program comprises a version of an icon corresponding to the application program.

6. The method of claim 1, further comprising scaling the icon representation based on user input.

7. The method of claim 1, wherein the type overlay corresponding to the application program is defined via an application programming interface (API).

8. The method of claim 1, wherein the identified type overlay is defined via an application programming interface (API).

9. One or more computer readable media storing computer executable instructions for performing the method of claim 1.

10. A computer-implemented method for displaying a type overlay on a thumbnail icon representing a data file stored on a computer system, comprising steps of:
a) identifying a thumbnail image corresponding to content of the data file;
b) when a user-defined global type overlay setting is on, determining a type overlay corresponding to the data file, and displaying on a display device a first icon representation of the data file, wherein the first icon representation comprises the thumbnail image and the type overlay corresponding to the data file; and
c) when the user-defined global type overlay setting is off, displaying on the display device a second icon representation of the data file, wherein the second icon representation comprises the thumbnail image without the type overlay corresponding to the data file.

11. The method of claim 10, wherein in step b) the determined type overlay comprises an icon corresponding to an application program with which the data file operates.

12. The method of claim 10, wherein in step b) the determined type overlay is identified by an application program with which the data file operates.

13. The method of claim 10, wherein in step b) the determined type overlay is identified via an application programming interface (API) exposed by an operating system of the computer system.

14. The method of claim 10, wherein in step a) the data file comprises a non-image native file format.

15. The method of claim 10, wherein in step b) the determined type overlay corresponds to a file type of the data file.

16. The method of claim 15, wherein step b) comprises:
i) determining that the file type is an ambiguous file type;
ii) analyzing contents of the data file; and
iii) identifying the type overlay corresponding to the data file based on the analysis of step ii).

17. The method of claim 16, wherein step ii) comprises analyzing metadata of the data file.

18. One or more computer readable media storing computer executable instructions for performing the method of claim 10.
